(19) United States
(12) Patent Application Publication
(10) Pub. No.: US 2009/0095088 A1
(43) Pub. Date: Apr. 16, 2009

(54) Device for Determining and/or Monitoring a Volume Flow and/or a Mass Flow

(75) Inventors: Andreas Berger, Reinach (CH); Achim Wiest, Weil am Rhein (DE); Patrick Oudoire, Soultz (FR)

Correspondence Address: BACON & THOMAS, PLLC, 625 SLATERS LANE, FOURTH FLOOR, ALEXANDRIA, VA, 22314-1176, US

(73) Assignee: Endress + Hauser Flowtec AG, Reinach (CH)

(21) Appl. No.: 11/795,894

(22) PCT Filed: Dec. 16, 2005
(86) PCT No.: PCT/EP2005/056858

§ 371 Date: May 21, 2008

(30) Foreign Application Priority Data
Jan. 24, 2005 (DE) 10 2005 003 398.9

(51) Int. Cl. G01F 1/00

(52) U.S. Cl. 73/861.25

(57) ABSTRACT

An apparatus for ascertaining and/or monitoring volume- and/or mass-flow of a measured medium flowing in a flow direction through a measuring tube of predetermined inner diameter. The apparatus includes a plurality of ultrasonic sensors, which transmit and/or receive ultrasonic measuring signals along different, defined measuring paths, and a control/evaluation unit, which ascertains volume- and/or mass-flow of the measured medium in a pipeline/in the measuring tube on the basis of the ultrasonic measuring signals according to a sound entrainment method or the echo principle. At least two ultrasonic sensors, which transmit and/or receive the ultrasonic measuring signals on different measuring paths, are positioned in an opening located in the wall of the measuring tube.

The invention relates to an apparatus for determining and/or monitoring volume- and/or mass-flow, e.g. flow rate, of a measured medium flowing in a flow direction through a measuring tube of predetermined inner diameter. The apparatus includes: A plurality of ultrasonic sensors, which transmit and/or receive ultrasonic measuring signals along different, defined measuring paths; and a control/evaluation unit, which ascertains volume- and/or mass-flow of the measured medium in the pipeline or in the measuring tube on the basis of the ultrasonic measuring signals according to a sound entrainment method or according to the echo principle.

In the case of inline flow-measuring systems, the flow profile is sensed by ultrasonic sensors arranged alongside one another. If the nominal diameter of the ultrasonic flow-measuring device is relatively small, then it is only possible with great effort that the ultrasonic sensors can be positioned alongside one another and transversely to the flow direction of the measured medium through the measuring tube. The reason lies especially therein, that, both due to acoustical as well as also technical reasons, the diameter of the ultrasonic sensors has a minimum size, and such size should not be fallen beneath. As a result, the separation of the ultrasonic sensors has a lower limit. In particular circumstances, therefore, a desired distribution of the ultrasonic sensors, or the corresponding measuring paths, of the ultrasonic flow-measuring device can not be achieved.

An object of the invention is to provide an ultrasonic flow-measuring device distinguished by a small track separation of the individual measuring paths.

The object is achieved by positioning in an opening in the wall of the measuring tube at least two ultrasonic sensors, which transmit and/or receive ultrasonic measuring signals on different measuring paths.

The sensor system of the invention enables, in simple manner, an increase in the desired number of measuring paths and thus achievement of smaller track separations between the measuring paths, whereby the measuring accuracy of the ultrasonic flow-measuring device can be improved. Moreover, the number and multiplicity of individual components is strongly reduced, so that manufacture of the flow-measuring device is enormously simplified.

According to a preferred embodiment of the apparatus of the invention, the ultrasonic sensors positioned in an opening of the tube wall of the measuring tube are formed as an integrated structural component dimensioned in such a way that it is positionable in the opening. Especially, the component is a sensor bar, on which the ultrasonic sensors are positioned rowlike; the corresponding opening is a hole whose cross section has a bar-shape corresponding to that of the sensor bar.

An idea of the invention is thus to integrate the ultrasonic sensors of the individual measuring paths into a structural component. This is achieved, for example, by the mentioned sensor bar, on which the transmitters/receivers are emplaced adjoining one another. This means that the piezoceramic ultrasonic transducers are brought together to form an integrated part, with the desired track separation being achieved e.g. by a corresponding partial coating of the ceramic. For installation of the now e.g. elongated sensors, the entrance holes of the ultrasonic measuring signals into the measured medium can likewise be coalesced, this leading, in the mentioned example, to said measuring tube hole with the cross section of bar-shape.

As already mentioned above, it is especially provided that the sensor bar is so positioned in the opening that the ultrasonic sensors are arranged alongside one another perpendicularly to the flow direction of the measured medium. Preferably, it is provided furthermore that the sensor bar is composed of a housing part with a base surface and side surfaces corresponding to the form of the base surface, and that the ultrasonic sensors are arranged on the base surface of the housing.

Furthermore, an advantageous embodiment of the apparatus of the invention provides that the ultrasonic sensors have a piezoceramic material, which is divided by separations of the conductive layer into different active zones; alternatively, it is provided that the piezoceramic material is applied in the form of a traversing or interrupted layer on the base surface of the housing.

Furthermore, it is proposed, that the ultrasonic sensors of a sensor bar are acoustically and mechanically decoupled from one another.

In order to achieve clean decoupling of the individual ultrasonic sensors from one another, an advantageous form of embodiment of the apparatus of the invention provides that the sensor bar is formed of a plurality of housing components, that at least one ultrasonic sensor is arranged on a base surface of each housing component, and that the individual housing components are connected together. For example, the individual housing components are welded together.

Especially in the case of measuring tubes of large nominal diameters, it is provided that the ultrasonic sensors of a sensor bar are arranged offset in height relative to one another and, indeed, in such a manner that they are oriented, in the mounted state, essentially tangentially to the inner wall of the measuring tube.

An alternative embodiment of the apparatus of the invention provides, moreover, that the opening in the tube wall is a bore and that a plurality of ultrasonic sensors are joined together in a structural component placeable into the bore. The integrated component has, thus, an essentially round diameter. Of course, the form of the integrated component, in which at least two ultrasonic sensors are brought together, can be embodied with any shape. The opening in the wall of the measuring tube is then embodied to correspond t$o the form of the integrated component.

The invention will now be explained in greater detail on the basis of the appended figures, which show as follows:

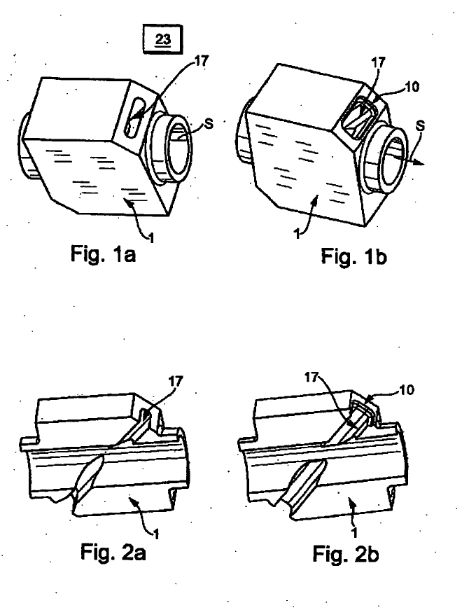

FIG. 1a a perspective, external view of a first embodiment of the ultrasonic flow-measuring device of the invention;

FIG. 1b a perspective, external view of a second embodiment of the ultrasonic flow-measuring device of the invention;

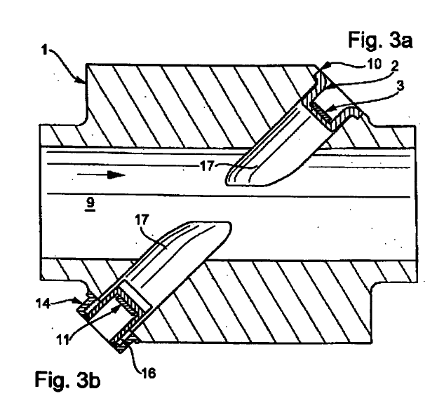

FIG. 2a a perspective, internal view of a section through the embodiment of FIG. 1a;

FIG. 2b a perspective internal view of a section through the embodiment of FIG. 1b;

FIG. 3a a longitudinal section through an ultrasonic flow-measuring device with a first form of embodiment of a sensor bar of the invention;

FIG. 3b a longitudinal section through an ultrasonic flow-measuring device with a second form of embodiment of a sensor bar of the invention;

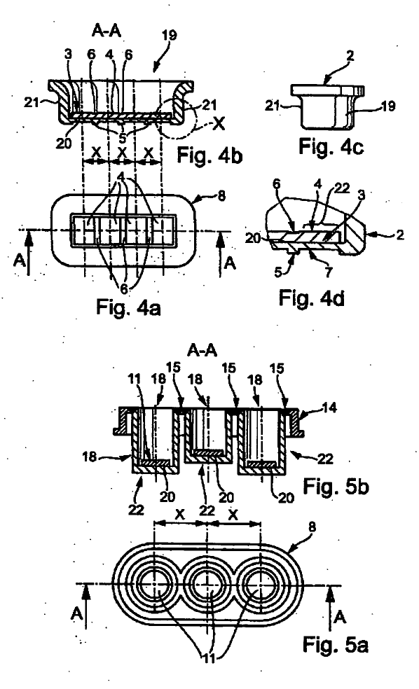

FIG. 4 different views and sections of a sensor bar shown in FIG. 3a, namely:
a) a top view of the sensor bar;
b) a longitudinal section according to the cutting plane A-A of FIG. 4a;
c) a side view of the sensor bar;
d) the circled region marked with X in FIG. 4b enlarged;

FIG. 5 different views and sections of the sensor bar shown in FIG. 3b, namely:
a) a top view of the sensor bar;
b) a longitudinal section according to the cutting plane A-A of FIG. 5a;

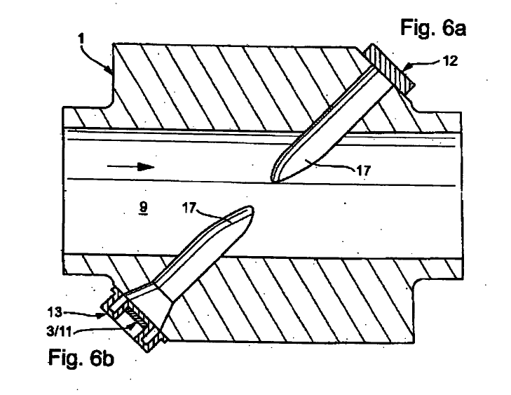

FIG. 6a a longitudinal section through an ultrasonic flow-measuring device with a third form of embodiment of a sensor bar of the invention;

FIG. 6b a longitudinal section through an ultrasonic flow-measuring device with a fourth form of embodiment of a sensor bar of the invention;

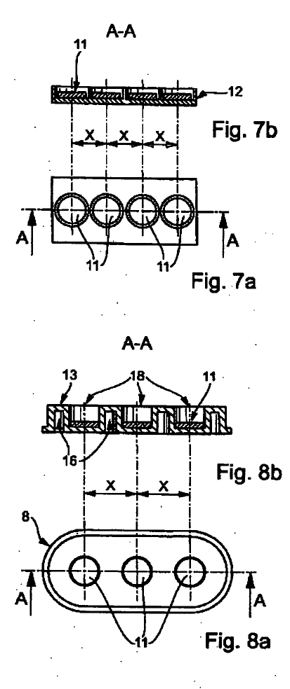

FIG. 7 different views and sections of the sensor bar shown in FIG. 6a, namely:
a) a top view of the sensor bar;
b) a longitudinal section taken according to the cutting plane A-A of FIG. 7a;

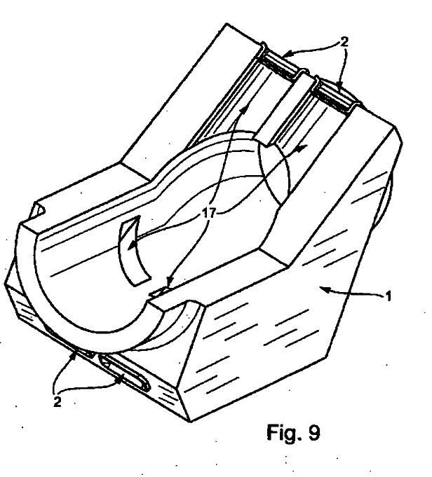

FIG. 8 different views and sections of the sensor bar shown in FIG. 6b, namely:
a) a top view of the sensor bar;
b) a longitudinal section taken according to the cutting plane A-A of FIG. 8a;

FIG. 9 a segmented, perspective view of a flow-measuring device with two sensor bars in the upper region and two sensor bars in the lower region of the measuring tube.

FIG. 1a shows a perspective, external view of a first embodiment of the measuring tube 1 of the invention for an ultrasonic flow-measuring device.

FIG. 1b shows a perspective, external view of a second embodiment of the measuring tube 1 of the invention for an ultrasonic flow-measuring device. FIGS. 2a and 2b show the corresponding perspective, internal views of the embodiments shown in FIGS. 1a and 1b.

Both types of measuring tubes 1 are embodied as flow-measuring devices, which work according to the travel-time difference principle and have, in each case, openings in the form of a hole 17 of elongated cross section in the upper region and in the lower region of the measuring tube. The holes 17 of elongated cross section and the corresponding installation geometries 8; 10 are so embodied and arranged that a plurality of ultrasonic sensors 22 arranged on a sensor bar 2; 12, 13, 14 can be positioned in each of the holes 17 of cross section elongated in bar-shape corresponding to that of the sensor bar. As shown, the form of embodiment shown in FIG. 1a has an installation geometry 10 in the form of a hole 17 of elongated cross section with rounded ends. In FIG. 1b, the form of the externally visible, installation geometry 10 of the hole 17 of elongated cross section is essentially rectangular, with rounded corners.

FIG. 3a,b shows a longitudinal section through an ultrasonic flow-measuring device. Two forms of embodiment of sensor bars 2, 14 are shown simultaneously, one in the top half, FIG. 3a, and the other in the bottom half, FIG. 3b. The form of embodiment of the sensor bar 2 of the invention shown in FIG. 3a is shown in detail in the FIGS. 4a-4d in different views and sections; the embodiment of the sensor bar 14 shown in FIG. 3b is shown in detail in FIGS. 5a and 5b.

FIG. 4a provides a top view of the sensor bar 2 of FIG. 3a. Construction of the sensor bar 2 is clear from the longitudinal section of FIG. 4b taken on the cutting plane A-A of FIG. 4a. This sensor bar is a preferred embodiment, since it can be manufactured via a coating process. The manufacturing costs are, therefore, relatively small. Alternatively, the sensor bar 2 can be manufactured by deep drawing of a suitable material.

Essential component of an ultrasonic transducer is a piezoceramic layer 3, which is excited via current- or voltage-signals for transmitting ultrasonic measuring signals. Analogously, ultrasonic measuring signals received by the piezoceramic layer 3 of an ultrasonic transducer are converted into electrical signals.

The traversing piezoceramic layer 3 shown in FIG. 4b can be applied relatively easily to the base surface 20 of the housing 19 using a coating process. The piezoceramic layer 3 is provided partially with a conductive coating 4 on the surface facing away from the base surface 20 in separated regions of the ultrasonic transducer 22. Via the ridges 5 on the outer side of the housing 19 facing away from the base surface 20 and via the portions of the electrical coating 4, as separated by the channels 6, a mechanical and acoustical decoupling of the adjoining ultrasonic transducers 22 is achieved. Of course, the piezoceramic components 7 can also be applied to the base surface 20 of the housing 19 by pressing them in place. Corresponding methods are known in the state of the art.

FIGS. 5a and 5b provide, respectively, a top view of the sensor bar 14 shown in FIG. 3b and a longitudinal section through the sensor bar 14 taken on the cutting plane A-A of FIG. 5 a.

Sensor bar 14 is constructed, in this case, not, as in the preceding example, of a housing 19 with a traversing base surface 20 and side surfaces 21, but, instead, is composed of a plurality of partially differently embodied housing components 18, with, in each case, an ultrasonic transducer 22, respectively, a piezoceramic 11 of round surface form being accommodated on the base surface 20 of each housing component 18. The ultrasonic transducers 22, respectively the piezoceramics 11, thus sit in individual housing vases or sensor pockets 18, with the housing vases or sensor pockets having at least partially different heights, or depths. The heights, or depths, are, in each case, to be so dimensioned that the individual ultrasonic transducers 22, respectively the piezoceramics 11, are, following mounting of the sensor bar 14 on the measuring tube 1, fitted essentially tangentially to the inner diameter of the measuring tube 1. In this way, the sensor bar 14 can be optimally fitted to a measuring tube 1 of predetermined inner diameter. The tangential arrangement of the escape surfaces of the ultrasonic transducers 22 to the inner surface of the measuring tube 1 is of advantage both for measuring and also for flow.

The individual housing components 18 are welded to neighboring parts via weld seams 15 in the regions of their upper edges away from the base surfaces 20. Alternatively, sensor bar 14 can also be manufactured as one part e.g. by appropriate material removal or machining. Of course, also in the case of this optimized embodiment of the sensor bar 14, the individual ultrasonic transducers 22 are mechanically and acoustically decoupled from one another.

The sensor bar 2 shown in FIG. 4 is so embodied that it can be inserted into the opening 10 shown in FIGS. 1b and 2b. The sensor bar 14 shown in FIG. 5 fits into the opening 17 shown in FIGS. 2a and 2b. Sensor bars 2, 14 can be secured via hold-downs or by means of screws in the opening 17. Also usable, in addition, are all known sealing methods. Sealing is achieved e.g. via a weld seam 15, an O-ring seal, or a flat seal or gasket.

FIG. 6a is a longitudinal section through an ultrasonic flow-measuring device having a third form of embodiment of a sensor bar 12 of the invention; FIG. 6b shows a longitudinal section through an ultrasonic flow-measuring device with a fourth form of embodiment of the sensor bar 13 of the invention. FIGS. 7 a, 7 b, 8 a and 8 b show further embodiments of the sensor bars 12, 13, with the details clearly visible, so that corresponding descriptions can be omitted.

FIG. 9 is a sectional, perspective view of a fill measuring device with two sensor bars 2 in the upper region and two sensor bars 2 in the lower region of the measuring tube 1. This form of embodiment with a plurality of sensor bars 2 is applicable especially in the case of fill measuring devices of large nominal diameters. Advantageous in the replacement of separately placed ultrasonic sensors 22 by the sensor bars 12, 13, 14 of the invention is the reduction of parts and their multiplicity, coupled with simultaneous increase in the number of measuring paths. Through the solution of the invention, manufacture of an ultrasonic flow-measuring device can be significantly simplified.

### LIST OF REFERENCE CHARACTERS

1 measuring tube
2 sensor bar
3 piezoceramic with rectangular surface shape
4 electrically conductive coating
5 ridge
6 channel
7 partial piezoceramic coating
8 transmitting, installation geometry of the sensor bar
9 measured medium
10 installation geometry of the ultrasonic sensor
11 piezoceramic of round surface shape
12 sensor bar
13 sensor bar
14 sensor bar
15 weld seam
16 cavity
17 opening/hole of elongated cross section/bore
18 housing component/sensor vase/pocket
19 housing
20 base surface
21 side surface
22 ultrasonic transducer/ultrasonic sensor
23 control/evaluation unit
24 bore
25 integrated structural component

1-10. (canceled)

11. An apparatus for ascertaining and/or monitoring volume- and/or mass-flow of a measured medium flowing through a measuring tube of predetermined inner diameter in a flow direction, comprising:
at least two ultrasonic sensors, which transmit and/or receive ultrasonic measuring signals along different, defined measuring paths; and
a control/evaluation unit, which ascertains volume- and/or mass-flow of the measured medium in a pipeline/in the measuring tube on the basis of the ultrasonic measuring signals according to a sound entrainment method or the echo principle, wherein:
said at least two ultrasonic sensors, which are positioned in an opening arranged in the wall of the measuring tube.

12. The apparatus as claimed in claim 11, wherein:
said ultrasonic sensors positioned in said opening of the wall of the measuring tube are embodied as an integrated structural component, which is so dimensioned that it can be positioned in said opening.

13. The apparatus as claimed in claim 12, wherein:
said structural component is a sensor bar, on which said at least two ultrasonic sensors are positioned rowlike and said opening is a hole of elongated cross section corresponding to said sensor bar.

14. The apparatus as claimed in claim 13, wherein:
said sensor bar is so positioned in said opening that said at least two ultrasonic sensors are arranged alongside one another perpendicularly to the flow direction of the measured medium.

15. The apparatus as claimed in claim 11, wherein:
said sensor bar comprises a housing part with a base surface and side surfaces corresponding to the form of said base surface; and
said at least two ultrasonic sensors are arranged on said base surface of said housing part.

16. The apparatus as claimed in claim 15, wherein:
said at least two ultrasonic sensors include a piezoceramic material and an electrically conductive layer;
said piezoceramic layer is divided into various active zones by channels in said conductive layer and/or said piezoceramic material is applied in the form of a traversing or interrupted layer on said base surface of said housing part.

17. The apparatus as claimed in claim 12, wherein:
said at least two ultrasonic sensors are acoustically and mechanically decoupled from one another.

18. The apparatus as claimed in claim 12, wherein:
said sensor bar includes a plurality of housing components each having a base surface, at least one of said at least two ultrasonic sensor is arranged on said base surface of each housing component, and said individual housing components are connected with one another.

19. The apparatus as claimed in claim 13, wherein:
said at least two ultrasonic sensors are so arranged that they are oriented, when mounted, essentially tangentially to the inner wall of the measuring tube.

20. The apparatus as claimed in claim 11, wherein:
said opening in the wall of the measuring tube is an opening having an essentially round shape; and
said at least two ultrasonic sensors are brought together in a structural component insertable into said opening.
